(19) United States
(12) Patent Application Publication
(10) Pub. No.: US 2016/0348816 A1
(43) Pub. Date: Dec. 1, 2016

(54) APPARATUS AND METHOD FOR GASKET COMPRESSION CONTROL

(71) Applicant: Virginia Transformer Corporation, Roanoke, VA (US)

(72) Inventor: Prabhat K. JAIN, Roanoke, VA (US)

(73) Assignee: Virginia Transformer Corporation, Roanoke, VA (US)

(21) Appl. No.: 14/721,332

(22) Filed: May 26, 2015

(51) Int. Cl. F16L 23/16; F16L 23/02

(52) U.S. Cl. CPC F16L 23/16; F16L 23/02

(57) ABSTRACT

A flange designed for gasket compression control. Flange may have a hollow inner portion surrounded by a substantially flat outer lip, in which there may be a number of boltholes. Flange may have at least one mechanical stopper extending outward from it in a position unobstructed by the gasket; there may be mechanical stoppers on either side of the gasket, separated into “external” and “internal” mechanical stoppers. Mechanical stopper may be of a height equal to or greater than the lower bound of the minimum safe range of the gasket, or alternatively may be paired with a mechanical stopper on another flange such that when the two are mated the combination of the two exceeds the minimum safe range. This value may typically be around twenty to thirty-five percent of the gasket's uncompressed thickness. Optionally, the space between the external and internal mechanical stoppers may be grooved to further serve as a guide.

### BACKGROUND

In a variety of mechanical applications, gaskets are used to create static seals between stationary members of a mechanical assembly and used to maintain that seal under the normal operating conditions of the mechanical assembly. Often, these conditions vary, and the gasket may be exposed to a wide range of temperatures, pressures, or hazards.

Improper placement of a gasket can lead to minor or even major problems in the remainder of the mechanical assembly. For example, if a gasket placed around a pipe is overtightened, part of the seal may intrude into the pipe, which may substantially increase the wear on the inner rim of the gasket; this may develop to the point where large portions of the gasket are being worn away, subjecting the system to contamination from the torn-away gasket material. Conversely, if the gasket is undertightened, it may be ineffective at sealing the flange or other mechanical assembly and the seal may leak; this may in turn present a major hazard to bystanders if the contents of the pipe are toxic or otherwise dangerous.

Various solutions exist for controlling the compression on a gasket in order to keep it within acceptable bounds and avoid these problems. If a flat gasket design is used, a user may have to periodically check the seal of the gasket, and, if necessary, retorque the compression on the gasket to the proper value or replace the gasket entirely. The initial inexpensiveness of the flat gasket design means that greater expenditure can be spent on maintenance of the seal without the design becoming uncompetitive. However, given that such designs may be prone to “seepage” and “weepage,” as well as to sudden ruptures, flat gaskets are generally limited in their application.

Another common solution is to use a grooved flange design paired with a gasket shaped to fit in the groove during normal use; this gasket might take the form of a circular ring or O-ring. One major problem with this solution, however, is that while the O-ring gaskets themselves may be relatively inexpensive and simple to manufacture, using them to seal a particular flange connection requires the use of more material in the flange connection, precise machining of the flange groove, and time-consuming assembly, making O-ring seals rather costly to put into place despite their low apparent price. Other problems may also develop on account of the use of an O-ring design. For example, a large portion of the surface of the O-ring design may be exposed to fluid attack, which may be problematic if the fluid is caustic or damaging to the O-ring material. Pressure fluctuations may also cause damage to the O-ring. Stress concentrations or even stress cracking may also develop from the flange groove, potentially resulting in early failure of the flange or piping system.

Alternatively, a gasket may be molded precisely to the contours of the flange it is to be placed on. This may offer superior performance but may be expensive and complicated to implement. Users may not readily have access to custom molded gaskets that fit the particular flanges that they are using, and may have to specially order or make them. If every flange has its own custom-made gasket, this may also increase inventory and storage requirements; the user may have to keep a spare gasket for every flange to be sealed instead of just a few spares that may be used interchangeably on a larger number of flanges.

### SUMMARY

A flange designed for gasket compression control may be described. Flange may have a hollow inner portion surrounded by a substantially flat outer lip, in which there may be a number of boltholes. Flange may have at least one mechanical stopper extending outward from it in a position unobstructed by the gasket; there may be mechanical stoppers on either side of the gasket. Mechanical stopper may be of a height equal to or greater than the lower bound of the minimum safe range of the gasket, or alternatively may be paired with a mechanical stopper on another flange such that when the two are mated the combination of the two exceeds the minimum safe range.

### BRIEF DESCRIPTION OF THE DRAWINGS

Advantages of embodiments of the present invention will be apparent from the following detailed description of the exemplary embodiments. The following detailed description should be considered in conjunction with the accompanying figures in which:

FIG. 1 shows an exemplary embodiment of a mechanical stopper used for gasket compression control.

FIG. 1A shows a detail view of an exemplary embodiment of a mechanical stopper used for gasket compression control.

FIG. 2 shows a three-dimensional view of an exemplary embodiment of a mechanical stopper used for gasket compression control.

FIG. 2A shows a detail view of an exemplary embodiment of a mechanical stopper used for gasket compression control.

### DETAILED DESCRIPTION

Aspects of the present invention are disclosed in the following description and related figures directed to specific embodiments of the invention. Those skilled in the art will recognize that alternate embodiments may be devised without departing from the spirit or the scope of the claims. Additionally, well-known elements of exemplary embodiments of the invention will not be described in detail or will be omitted so as not to obscure the relevant details of the invention.

As used herein, the word “exemplary” means “serving as an example, instance or illustration.” The embodiments described herein are not limiting, but rather are exemplary only. It should be understood that the described embodiments are not necessarily to be construed as preferred or advantageous over other embodiments. Moreover, the terms “embodiments of the invention”, “embodiments” or “invention” do not require that all embodiments of the invention include the discussed feature, advantage or mode of operation.

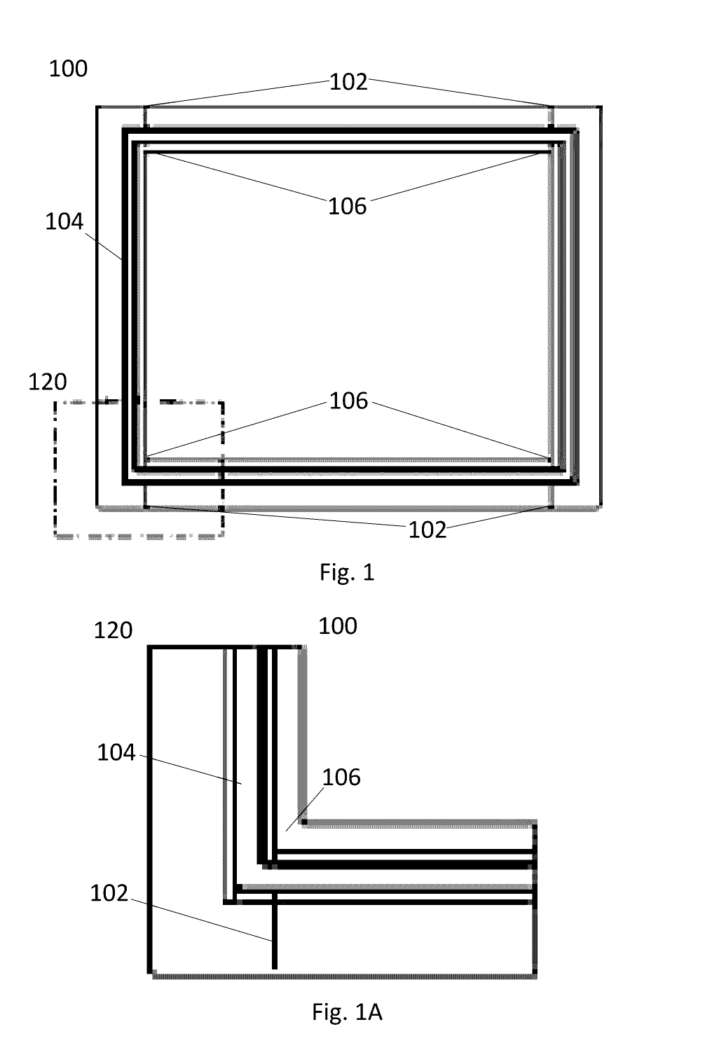

Referring now to exemplary FIG. 1, a flange 100 suitable for gasket compression control may be described. Flange 100 may have a hollow inner portion and a flared, substantially flat outer lip, and may be of any shape desired; for example, it may be round, square, rectangular, or another shape. Flared, substantially flat outer lip may have a number of boltholes by which flange 100 may be mated to another flange 100, or may have another structure suitable for mating to another flange 100. Flange 100 may accommodate a gasket 104 that extends contiguously around the perimeter of the flange 100, and may have a number of mechanical stoppers 102, 106 suitable to restrict the compression of the gasket 104 when the flange 100 is made part of a flange connection. Mechanical stoppers 102, 106 may be spaced at appropriate locations around the perimeter of the flange 100, for example at regularly spaced locations or near key points like the corners of the flange 100. Other flange embodiments 100 and other mechanical stopper placement 102, 106 may be envisioned; for example, if the flange is round or rounded, mechanical stoppers may be placed radially, or as desired.

Mechanical stoppers 102, 106 may be part of the design of the flange 100, and may be produced along with the flange 100 as a single part by a method appropriate to produce the flange 100, for example by forging. According to an alternative embodiment, mechanical stoppers 102, 106 may be securely joined or fastened to the flange later on, for example by welding, soldering or adhesive bonding.

According to an exemplary embodiment, mechanical stoppers 102, 106 may be separated into mechanical stoppers placed externally from the gasket 102 (“outer mechanical stoppers”) and mechanical stoppers placed internally from the gasket 106 (“inner mechanical stoppers”). According to some embodiments, only outer mechanical stoppers 102 may be employed, or only inner mechanical stoppers 106 may be employed, or both, as desired. According to other embodiments, a single internal or external mechanical stopper 102, 106 extending around the perimeter of the flange 100 may be used in place of a multiplicity of internal or external mechanical stoppers 102, 106, as desired.

Mechanical stoppers 102, 106 may extend from the surface of the flange 100 in portions not covered by the gasket 104. According to an exemplary embodiment, mechanical stoppers 102, 106 may extend from the surface of the flange 100 for a distance that allows the flange 100 to be compressed but which does not allow the gasket 104 to be compressed outside of the specified safe range for a particular gasket 104. Depending on the gasket 104 to be used, the specified safe range may vary; according to some embodiments, the minimum safe range may be between twenty percent and thirty-five percent of the gasket's uncompressed width, depending on factors like the gasket 104 size and material used. Other gaskets 104 may have minimum safe ranges outside of these values, and different sizes of mechanical stoppers 102, 106 may be used. Different shapes of mechanical stoppers 102, 106 may also be used; for example, according to some embodiments, mechanical stoppers 102, 106 may be rounded, may be rectangular, may be curved, or may be any other shape desired. According to one exemplary embodiment, mechanical stoppers 102, 106 may be added to only one flange 100 in a flange connection; according to an alternative embodiment, mechanical stoppers 102, 106 may be added to both flanges 100 in a flange connection. According to the second embodiment, mechanical stoppers 102, 106 may be sized to be approximately half of the width of the lower bound of the minimum safe range rather than approximately the width of the lower bound of the minimum safe range; this may ensure that when one flange 100 is mated to another in a flange connection, the flanges 100 are held apart by a distance approximately that of the lower bound minimum safe range of the gasket 104. Alternate widths, such as the upper bound of the minimum safe range or another width, may also be used.

According to another embodiment, mechanical stoppers 102, 106 may overlap with the gasket 104; for example, gasket 104 may be a flat-type gasket having a number of holes near the perimeter (such as boltholes), and mechanical stoppers 102, 106 may be placed approximately where those holes are located. Mechanical stoppers 102, 106 may be interspersed with boltholes, as desired. According to one exemplary embodiment, a flat-type flange gasket 104 may have eight boltholes evenly spaced around the perimeter of the flange gasket, and a flange design 100 with which it may be paired may have four bolts extending through the flange at the 0°, 90°, 180°, and 270° points, and may have four round mechanical stoppers 102, 106 approximately the same size as the boltholes at the 45°, 135°, 225°, and 315° points. According to an alternative embodiment, mechanical stoppers 102, 106 and boltholes may overlap; for example, the boltholes may have a raised edge, rim, or outer perimeter that extends from the surface of the flange 100, such that when a flange connection is made the raised edges of the boltholes come into contact and prevent a flush connection between the two flanges 100 from being formed. The width of this gap between flanges 100 may be a function of the width of a standard gasket 104 and its maximum compressibility; for example, according to an embodiment in which the gasket 104 may be safely compressed to approximately twenty-five percent of its maximum width, the raised rims of the boltholes may each have a height of approximately fifteen percent of the width of the gasket 104. This may ensure that when the two flanges are mated, a gasket 104 placed between them will not be compressed for more than the maximum level it may accommodate. Mechanical stoppers 102, 106 intended to be used on both parts of a mated pair of flanges 100 need not be the same uniform height; for example, if the mated pair of flanges 100 is intended to accommodate a gasket 104 with a minimum safe width of thirty-five percent of the gasket's uncompressed width, some of the mechanical stoppers 102, 106 may have a height of ten percent of the gasket's uncompressed width and some of the mechanical stoppers may have a height of twenty-five percent of the gasket's uncompressed width, such that when the two flanges 100 are paired the mechanical stoppers 102, 106 space the two flanges 100 apart by a combined total of thirty-five percent of the gasket's uncompressed width. Other combinations, such as one percent and thirty-four percent of the gasket's uncompressed width, may be envisioned; negative widths, effectively representing holes in the flange 100, may also be envisioned and may allow the flanges 100 to interlock when mated. According to another embodiment, a similar interlocking effect between mechanical stoppers 102, 106 may be created by employing mechanical stoppers 102, 106 that do not have a bottom surface parallel to the surface of the flange 100; for example, the bottom surfaces of mechanical stoppers 102, 106 may be angled or curved.

Alternatively, each flange 100 may have its own mechanical stoppers that extend for thirty-five percent of the gasket's uncompressed width, but the mechanical stoppers 102, 106 on each may be placed such that the two do not interfere with each other. For example, mechanical stoppers 102, 106 may be placed only on the right side of the flange 100, such that when two such flanges 100 are paired, the mechanical stoppers 102, 106 may be on separate sides of the connection.

Alternatively, no standard gasket 104 sizing may be used, and mechanical stoppers 102, 106 may be sized to the gasket 104 or otherwise adjusted to an appropriate size instead. For example, according to one exemplary embodiment, mechanical stoppers 102, 106 may not be securely fastened to the flange surface 100, and may instead be held in place by bolts similarly to nuts or washers.

Mechanical stoppers 102, 106 may be composed of different materials, or may be differently treated; for example, according to an exemplary embodiment wherein the center walls of the flange 100 are treated to resist corrosion and fluid wear, the inner mechanical stoppers 106 may be similarly treated but the outer mechanical stoppers 102 may not be. According to an alternative exemplary embodiment, the internal and external surfaces of the flange 100 may be composed of different materials; the mechanical stoppers 102, 106 may likewise be composed of different materials.

Gasket 104 may be any type of gasket or seal. According to one exemplary embodiment, gasket 104 may be a flat-type gasket, and the outer mechanical stopper 102 and the inner mechanical stopper 106 may serve as guides for the gasket 104. The outer mechanical stopper 102 and inner mechanical stopper 106 may be spaced apart by approximately the thickness of the gasket 104 such that the gasket 104 fits between them when put into place. Gasket 104 fit may be snug or may be loose, as desired; this may also depend on factors like the choice of gasket 104, such as the choice of a flat gasket design over an O-ring gasket design. Gasket 104, if flat, may be secured in place by a plurality of bolts that may also be used to tighten the flange 100; according to one exemplary embodiment, there may be a plurality of boltholes extending through the flange 100 and a number of boltholes extending through the gasket 104 in approximately the same distribution as on the flange 100, such that bolts may be passed through the flange 100 and gasket 104 simultaneously and both secured in place. Other methods of securing may also be employed.

According to an alternative embodiment, flange 100 may have a guide groove sized to accommodate a gasket 104, and gasket 104 may be placed within or aligned with the guide groove, with mechanical stoppers 102, 106 then extending for a distance exceeding the lower bound of the minimum safe compression range of the gasket. The use of mechanical stoppers 102, 106 paired with a guide groove may allow for a shallower groove that requires less complicated machining to add; alternatively, guide groove may be added by another method, for example during the initial forging step or by chemical etching. The reduced need for complicated machining may in turn reduce the cost of producing the flange 100.

According to a third embodiment, an alternative method of holding the gasket 104 in place may be employed, or another method of sealing may be used. For example, the surface of the flange 100 may be coated with sealant, which may dry in the form of a seal; mechanical stoppers 102, 106 may then be used to ensure that there is not an excess amount of compression on the seal.

Referring now to exemplary FIG. 1A, a detail view 120 of flange 100 may be provided. Flange 100 may have a hollow inner portion and a flared, substantially flat outer lip, may have an outer mechanical stopper 102, may have a gasket 104 or geometry accommodating the insertion of a gasket 104, and may have an inner mechanical stopper 106. According to one exemplary embodiment, inner mechanical stopper 106 may be a single solid piece that extends around the inner perimeter of the flange 100, while a plurality of external mechanical stoppers 102 may be spaced around the outer perimeter of the flange 100. The use of a single solid piece as the inner mechanical stopper 106 may have numerous advantages; for example, it can help ensure that the gasket 104 is properly positioned by providing a frame around which the gasket 104 may be stretched or otherwise positioned. Other embodiments of mechanical stoppers may be envisioned.

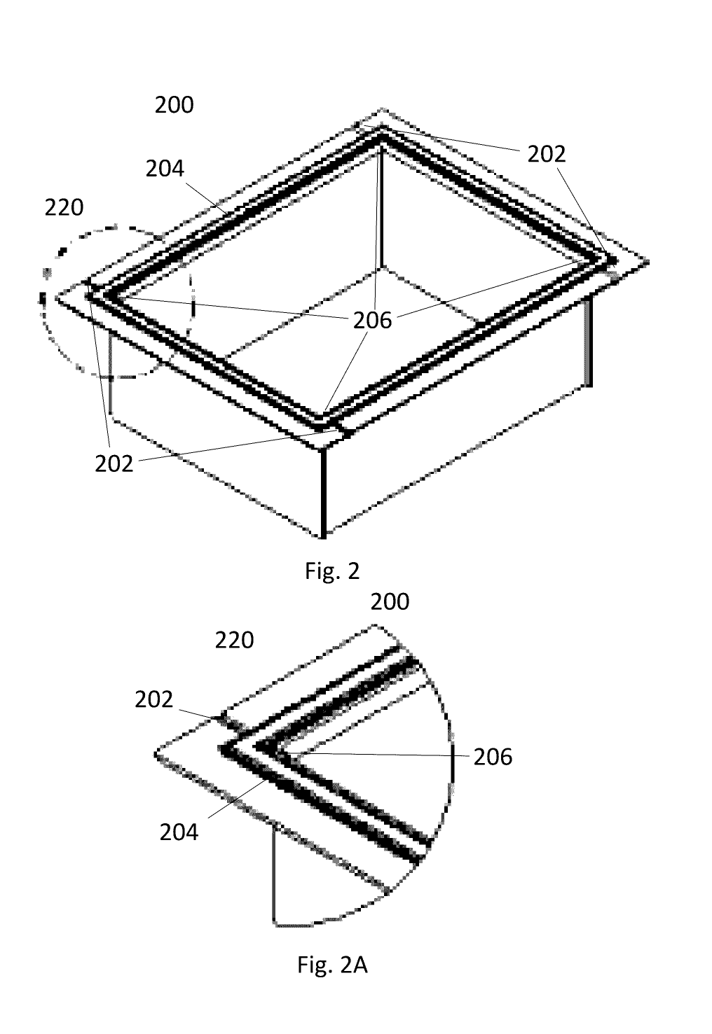

Referring now to exemplary FIG. 2, a three-dimensional view of a flange 200 may be provided. Flange 200 may have a hollow inner portion and a flared, substantially flat outer lip, may have an outer mechanical stopper 202, may have a gasket 204 or geometry accommodating the insertion of a gasket 204, and may have an inner mechanical stopper 206.

Referring now to exemplary FIG. 2A, a detail view 220 of flange 200 may be provided. Flange 200 may have a hollow inner portion and a flared, substantially flat outer lip, may have an outer mechanical stopper 202, may have a gasket 204 or geometry accommodating the insertion of a gasket 204, and may have an inner mechanical stopper 206.

The foregoing description and accompanying figures illustrate the principles, preferred embodiments and modes of operation of the invention. However, the invention should not be construed as being limited to the particular embodiments discussed above. Additional variations of the embodiments discussed above will be appreciated by those skilled in the art.

Therefore, the above-described embodiments should be regarded as illustrative rather than restrictive. Accordingly, it should be appreciated that variations to those embodiments can be made by those skilled in the art without departing from the scope of the invention as defined by the following claims.

What is claimed is:

1. A flange, comprising:
A hollow inner portion;
A flared, substantially flat outer lip;
At least one mechanical stopper extending outward from the flared, substantially flat outer lip; and
At least one guide restricting placement of the gasket.

2. The flange of claim 1, wherein the at least one mechanical stopper is affixed to the surface of the flange by at least one of the set of: welding, soldering, and adhesive bonding.

3. The flange of claim 1, wherein the at least one mechanical stopper and the flange are formed as a single part.

4. The flange of claim 1, wherein the at least one mechanical stopper extends outward from the surface of the flange for a distance between ten percent of the uncompressed gasket width and thirty-five percent of the uncompressed gasket width.

5. The flange of claim 1, wherein the at least one guide restricting placement of the gasket is a mechanical stopper.

6. The flange of claim 1, wherein the at least one guide restricting placement of the gasket is a groove sized to accommodate a gasket.

7. The flange of claim 1, wherein the flange possesses a plurality of mechanical stoppers, this plurality of mechanical stoppers comprising at least one internal mechanical stopper and at least one external mechanical stopper.

8. The flange of claim 1, wherein the flange is rectangular.

9. The flange of claim 8, wherein the flange possesses a plurality of mechanical stoppers, and wherein said mechanical stoppers are arranged substantially close to the corners of the flange.

10. The flange of claim 1, wherein the flared, substantially flat outer lip includes a number of boltholes.

11. The flange of claim 10, wherein the flange possesses a plurality of mechanical stoppers, and wherein said mechanical stoppers are arranged substantially close to the boltholes in the flared, substantially flat outer lip.

12. The flange of claim 1, wherein the flange includes a gasket.

13. The flange of claim 12, wherein the gasket is placed such that it does not obstruct any of the mechanical stoppers.

14. The flange of claim 12, wherein the flange possesses a plurality of mechanical stoppers, this plurality of mechanical stoppers comprising at least one internal mechanical stopper and at least one external mechanical stopper, and wherein the gasket is placed between the at least one internal mechanical stopper and the at least one external mechanical stopper.

15. A method for modifying a pipe flange to reduce overcompression of gaskets, said method comprising:
Identifying a flange connection between multiple pipe flanges that may be fitted with a gasket;
Identifying a gasket to be used in conjunction with that flange connection;
Identifying the minimum safe range to which the gasket can be safely compressed;
Identifying portions of the surface of at least one of the flanges that will not be obstructed by the gasket when the gasket is in place;
Affixing at least one mechanical stopper to those identified portions of the surface of at least one of the flanges such that the at least one mechanical stopper extends outward from the surface of the at least one flange;
Wherein said at least one mechanical stopper separates one flange from another flange in the flange connection by at least the lower bound of the gasket minimum safe range when the flanges are mated to each other in the flange connection.

16. The method of claim 15, wherein the at least one mechanical stopper is affixed to the surface of at least one flange by at least one of the set of: welding, soldering, and adhesive bonding.

17. The method of claim 15, wherein the at least one mechanical stopper is affixed to the surface of a flange and extends outward from the surface of the flange for a distance between twenty percent of the uncompressed gasket width and thirty-five percent of the uncompressed gasket width.

18. The method of claim 12, wherein a first flange is mated with a second flange having mechanical stoppers in substantially the same locations as on the first flange.

19. The method of claim 18, wherein the at least one mechanical stopper is affixed to the surface of the first flange and extends outward from the surface of the first flange for a distance between ten percent of the uncompressed gasket width and twenty-five percent of the uncompressed gasket width.

20. The method of claim 18, wherein there are a plurality of mechanical stoppers and wherein at least one of the mechanical stoppers affixed to the first flange contacts at least one of the mechanical stoppers affixed to the second flange.
